(19) United States
(12) Patent Application Publication
(10) Pub. No.: US 2007/0046180 A1
(43) Pub. Date: Mar. 1, 2007

(54) ORGANIC ELECTRO-LUMINESCENCE ELEMENT AND ORGANIC ELECTRO-LUMINESCENCE DISPLAY

(76) Inventors: Yi-Lung Kao, Taoyuan County (TW); Ya-Ping Tsai, Nantou County (TW); Chih-Kwang Tzen, Pingtung County (TW); Liang-Yuan Wang, Taipei County (TW); Shuenn-Jiun Tang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,078

(22) Filed: Aug. 29, 2005

(51) Int. Cl. H01J 1/62; H01J 63/04

(52) U.S. Cl. 313/504

(57) ABSTRACT

An organic electro-luminescence element and an organic electro-luminescence display are provided. The organic electro-luminescence display includes a substrate and a plurality of organic electro-luminescence elements disposed in array on the substrate. The organic electro-luminescence element includes a first electrode layer, an organic luminescent layer, a second transparent electrode layer, a first transparent filler layer, a second transparent filler layer and a semitransparent layer. Wherein, the organic luminescent layer is disposed on the first electrode layer, and the second transparent electrode layer is disposed on the organic luminescent layer. The first transparent filler layer and the second transparent filler layer are disposed on the second transparent electrode layer, and the thickness of the second transparent filler layer is larger than the thickness of the first transparent filler layer. The semitransparent layer covers the first transparent filler layer and the second transparent filler layer.

### BACKGROUND OF THE INVENTION

1. Field of the Invention

The present invention relates to a luminescent element and a display apparatus. More particularly, the present invention relates to an organic electro-luminescence element and an organic electro-luminescence display (OELD).

2. Description of Related Art

Display apparatuses are the communication interface between people and information. Now the major display apparatuses are the flat panel display apparatuses. Wherein, the organic electro-luminescence displays have many advantages, such as self-luminescence, wide view angle, energy-saving, simple manufacturing process, low production cost, low operation temperature, fast responsive speed and full-colors. With all the listed advantages, organic electro-luminescence display apparatuses are very likely to be the major flap panel display apparatuses in the near future.

Because the life spans of the conventional organic luminescent materials are inconsistent, their applicability is limited. For instance, due to the different life spans of the red, green and blue organic luminescent materials, the performance of the organic luminescent materials decay in different timing and thus the hues become unbalanced. In order to avoid the inconsistency of organic luminescent materials, researchers have developed an emission structure combining organic electro-luminescence elements and color filters to utilize a single-colored organic luminescent material in a single display apparatus.

FIG. 1 is a cross sectional view of part of a conventional organic electro-luminescence display. The conventional organic electro-luminescence display consists of a plurality of organic electro-luminescence elements in array, and only one organic electro-luminescence element is shown in FIG. 1. The part of the organic electro-luminescence display shown in FIG. 1 includes a substrate 110, an anode layer 120, an organic luminescent layer 130, a cathode layer 140 and a color filter substrate 150. Wherein, the anode layer 120, the organic luminescent layer 130 and the cathode layer 140 are disposed on the substrate 110 in turn, and the organic luminescent layer 130 suits to emit white light. Meanwhile, the color filter substrate 150 consists of two glass substrates 152 and the red color filter R10, the green color filter G10 and the blue color filter B10 sealed between the substrates 152.

In the organic electro-luminescence display with the design described above, due to the collation of the white light organic luminescent layer 130, the red color filter R10, the green color filter G10 and the blue color filter B10 for colourful display, the different decay rates of the different kinds organic luminescent layers can be avoided. However, the transmittances of white light to the red color filter R10, the green color filter G10 and the blue color filter B10 are different, so that the color uniformity of the image is still poor.

### SUMMARY OF THE INVENTION

Accordingly, the present invention is directed to an organic electro-luminescence element with higher intensities of light in designated wavelengths.

The present invention is also directed to an organic electro-luminescence display with better color uniformity of the image.

According to an embodiment of the present invention, an organic electro-luminescence element is provided. The organic electro-luminescence element includes a first electrode layer, an organic luminescent layer, a second transparent electrode layer, a first transparent filler layer, a second transparent filler layer and a semitransparent layer. Wherein, the organic luminescent layer is disposed on the first electrode layer, and the second transparent electrode layer is disposed on the organic luminescent layer. The first transparent filler layer and the second transparent filler layer are disposed on the second transparent electrode layer, and the thickness of the second transparent filler layer is larger than the thickness of the first transparent filler layer. Else, the semitransparent layer covers the first transparent filler layer and the second transparent filler layer.

According to an embodiment of the present invention, the organic electro-luminescence element further comprises a first color filter and a second color filter. The first color filter and the second color filter are disposed on the semitransparent layer and set above the first transparent filler layer and the second transparent filler layer, respectively. Otherwise, the organic electro-luminescence element may further comprise a transparent planar layer. The transparent planar layer covers the semitransparent layer, and the first color filter and the second color filter are disposed on the transparent planar layer. Moreover, the organic electro-luminescence element may further comprise a passivation layer that covers the transparent planar layer, the first color filter and the second color filter. Or, the organic electro-luminescence element may further comprise a cover substrate optionally that covers above the transparent planar layer, the first color filter and the second color filter.

According to another embodiment of the present invention, the organic electro-luminescence element may further comprise a third transparent filler layer that disposed on the second transparent electrode layer. The thickness of the third transparent filler layer is larger than the thickness of the second transparent filler layer, and the third transparent filler layer is covered by the semitransparent layer. Moreover, the organic electro-luminescence element may further comprise a first color filter, a second color filter and a third color filter that disposed on the semitransparent layer and set above the first transparent filler layer, the second transparent filler layer and the third transparent filler layer, respectively. Wherein, the first color filter, the second color filter and the third color filter could be the red color filter, the green color filter and the blue color filter, respectively. Otherwise, the organic electro-luminescence element may further comprise a transparent planar layer that covers the semitransparent layer, and the first color filter, the second color filter and the third color filter are disposed on the transparent planar layer. Besides, the organic electro-luminescence element may further comprise a passivation layer that covers the transparent planar layer, the first color filter, the second color filter and the third color filter. Or, the organic electro-luminescence element may further comprise a cover substrate that covers above the transparent planar layer, the first color filter, the second color filter and the third color filter.

According to more another embodiment of the present invention, the organic electro-luminescence element may further comprise a substrate, and the first electrode layer is disposed on the substrate. Wherein, the substrate could be the glass substrate, the silicon substrate or the sapphire substrate, and the substrate also could be the thin film transistor (TFT) array substrate.

According to still another embodiment of the present invention, the semitransparent layer of the organic electro-luminescence element could be a distributed Bragg reflector (DBR) or a metal layer.

According to still another embodiment of the present invention, the organic luminescent layer of the organic electro-luminescence element could be the white light organic luminescent layer.

According to another embodiment of the present invention, an organic electro-luminescence display is provided. The organic electro-luminescence display includes a substrate and a plurality of organic electro-luminescence elements disposed in array thereon. Each of the organic electro-luminescence elements includes a first electrode layer, an organic luminescent layer, a second transparent electrode layer, a first transparent filler layer, a second transparent filler layer, a semitransparent layer, a first color filter and a second color filter. Wherein, the first electrode layer is disposed on the substrate, the organic luminescent layer is disposed on the first electrode layer, and the second transparent electrode layer is disposed on the organic luminescent layer. The first transparent filler layer and the second transparent filler layer are disposed on the second transparent electrode layer, and the thickness of the second transparent filler layer is larger than the thickness of the first transparent filler layer. The first transparent filler layer and the second transparent filler layer are covered by the semitransparent layer. The first color filter and the second color filter are disposed on the semitransparent layer and set above the first transparent filler layer and the second transparent filler layer, respectively.

According to an embodiment of the present invention, each of the organic electro-luminescence elements of the organic electro-luminescence display may further comprise a transparent planar layer that covers the semitransparent layer, and the first color filter and the second color filter are disposed on the transparent planar layer.

According to another embodiment of the present invention, each of the organic electro-luminescence elements of the organic electro-luminescence display may further comprise a third transparent filler layer and a third color filter. The third transparent filler layer is disposed on the second transparent electrode layer, and the thickness of the third transparent filler layer is larger than the thickness of the second transparent filler layer. The third transparent filler layer is covered by the semitransparent layer. The third color filter is disposed on the semitransparent layer and set above the third transparent filler layer. Moreover, the first color filter, the second color filter and the third color filter could be the red color filter, the green color filter and the blue color filter, respectively. Otherwise, each of the organic electro-luminescence elements may further comprise a transparent planar layer that covers the semitransparent layer, and the first color filter, the second color filter and the third color filter are disposed on the transparent planar layer.

According to more another embodiment of the present invention, the organic electro-luminescence display may further comprise a passivation layer that covers the organic electro-luminescence elements. Or, the organic electro-luminescence display may further comprise a cover substrate that covers above the organic electro-luminescence elements.

According to still another embodiment of the present invention, the substrate of the organic electro-luminescence display could be the glass substrate, the silicon substrate or the sapphire substrate, and the substrate also could be the thin film transistor (TFT) array substrate.

According to still another embodiment of the present invention, the semitransparent layers of the organic electro-luminescence display could be a distributed Bragg reflector or a metal layer.

According to still another embodiment of the present invention, the organic luminescent layers of the organic electro-luminescence display could be the white light organic luminescent layer.

With more than two kinds of thickness of the filler layers in the organic electro-luminescence element and the organic electro-luminescence display of the invention, two or more resonant cavities with different resonant distances could be formed, and the light intensity in designated wavelengths. Moreover, the lengths of the resonant cavities could be adjusted according to the characters of the collocating color filters for improving the color uniformity of the image.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross sectional view of part of a conventional organic electro-luminescence display.

FIG. 2 is a cross sectional view of an organic electro-luminescence element according to an embodiment of the present invention.

FIGS. 3A-3C are cross sectional views of the organic electro-luminescence elements according to another three embodiments of the present invention.

FIG. 4 is a schematic drawing of an organic electro-luminescence display according to an embodiment of the present invention.

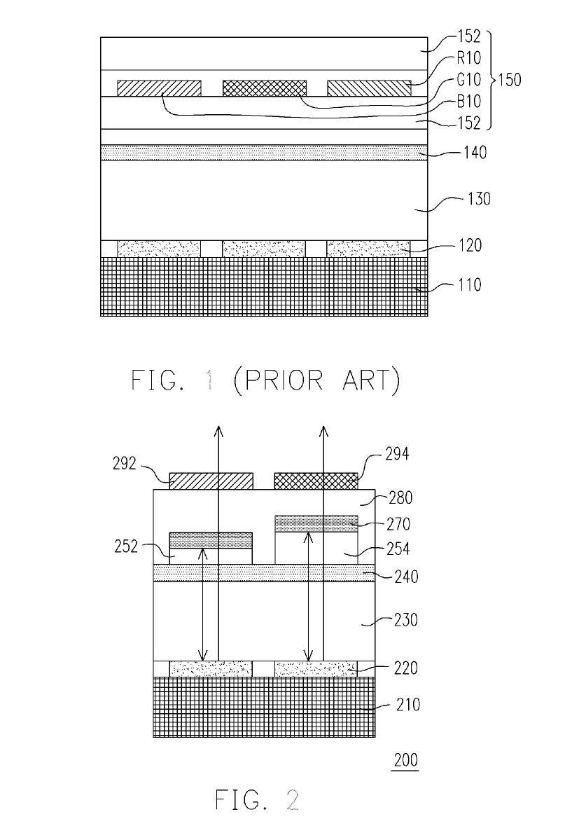

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a cross sectional view of an organic electro-luminescence element according to an embodiment of the present invention. Referring to FIG. 2, the organic electro-luminescence element 200 in this embodiment essentially includes a first electrode layer 220, an organic luminescent layer 230, a second transparent electrode layer 240, two transparent filler layers 252 and 254 and a semitransparent layer 270. Otherwise, the layers described above might be formed on a substrate 210. The substrate 210 could be the glass substrate, the silicon substrate, the sapphire substrate or the substrate with other proper material. Else, the substrate 210 also could be the substrate with the active elements, such as the thin film transistors, formed thereon.

Referring to FIG. 2, the first electrode layer 220 may be disposed on the substrate 210 while the substrate 210 is used. The first electrode layer 220 is used as the anode usually, and the first electrode layer 220 is better to have the reflectivity while used in top emission type organic electro-luminescence element. The first electrode layer 220 could be constituted with single metal layer or laminated with high work function conductive material, such as indium tin oxide (ITO), and metal with high reflectivity, such as Ag, Al or others. The organic luminescent layer 230 is disposed on the first electrode layer 220, and the organic luminescent layer 230 described in this embodiment suits to emit white light, for example. The second transparent electrode layer 240 is disposed on the organic luminescent layer. The second transparent electrode layer 240 is used as the cathode usually, and the material of the second transparent electrode layer 240 is better to be the transparent conductive material, such as the ITO.

Otherwise, the transparent filler layer 252 and 254 are disposed on different positions of the second transparent electrode layer 240, and the thickness of the transparent filler layer 254 is larger than the thickness of the transparent filler layer 252. For example, the material of the transparent filler layers 252 and 254 can be the oxide, the nitride or other proper transparent material, such as silicon oxide (SiO2) and silicon nitride (SiNx). The semitransparent layer 270 covers the transparent filler layers 252 and 254, and the parts of the semitransparent layer 270 that located respectively on the transparent filler layer 252 and 254 could be separated or connected with each other. The semitransparent layer 270 could be the semitransparent metal layer (such as Ag and Al) or one or more pairs of the distributed Bragg reflectors.

With the foregoing design, when the current is applied through the first electrode layer 220 and the second transparent electrode layer 240 on the organic luminescent layer 230, the light emit by the organic luminescent layer 230 could directly pass through the second transparent electrode layer 240 or pass through the second transparent electrode layer 240 after reflected by the first electrode layer 220 and sequentially emit out. Meanwhile, the light will be reflected partially by the semitransparent layer 270 after passed through the second transparent electrode layer 240, and then reflected resonantly between the semitransparent layer 270 and the first electrode layer 220. It is noted that two kinds of resonant distances exist owing to the different thicknesses of the transparent filler layers 252 and 254, such that the resonated light will have higher intensity and purity in designated wavelengths.

With the feature described above, if a color filter 292 and a color filter 294 are further disposed on the semitransparent layer 270 and set above the transparent filler layers 252 and 254 in the organic electro-luminescence element 200, the intensities of the light with the wavelengths that suit to pass through the color filters 292 and 294 can be enhanced by controlling the thickness of the transparent filler layers 252 and 254, and the intensities and purities of the color lights that passed through the color filters 292 and 294 can be improved. With the increases of the amounts and purities of the color lights that passed through the color filters 292 and 294, if the color filters 292 and 294 are respectively blue and yellow color filters, the lightness and the color rendering property of the white light that mixed with the color lights can be improved.

Moreover, the organic electro-luminescence element 200 may further includes a transparent planar layer 280 that covers the semitransparent layer 270, and the color filters 292 and 294 are disposed on the transparent planar layer 280. The transparent planar layer 280 can be used to flatten the surface and keep the outer moister, oxygen and other impurities away from the organic electro-luminescence element 200. Of course, for protecting the color filters 292 and 294, the transparent planar layer 280, color filter 292 and 294 of the organic electro-luminescence element 200 also could be covered by a passivation layer (not shown) or a cover substrate (not shown).

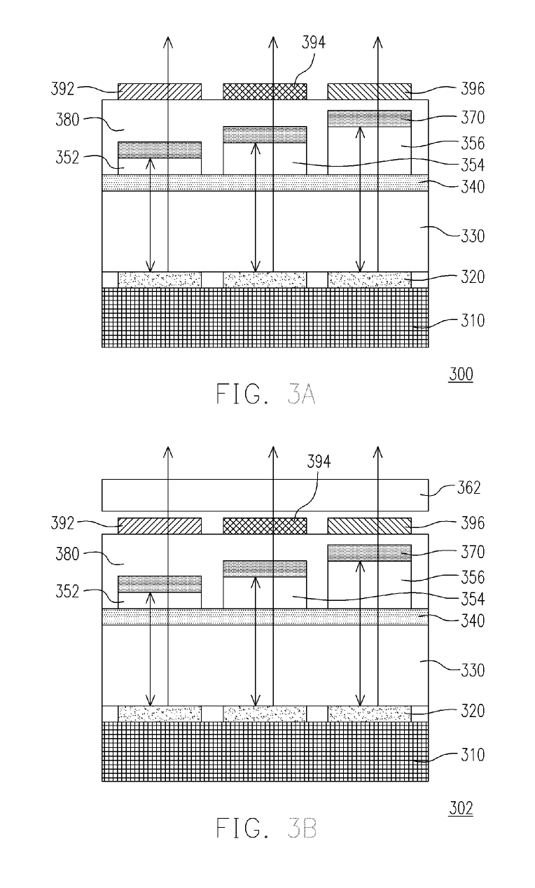

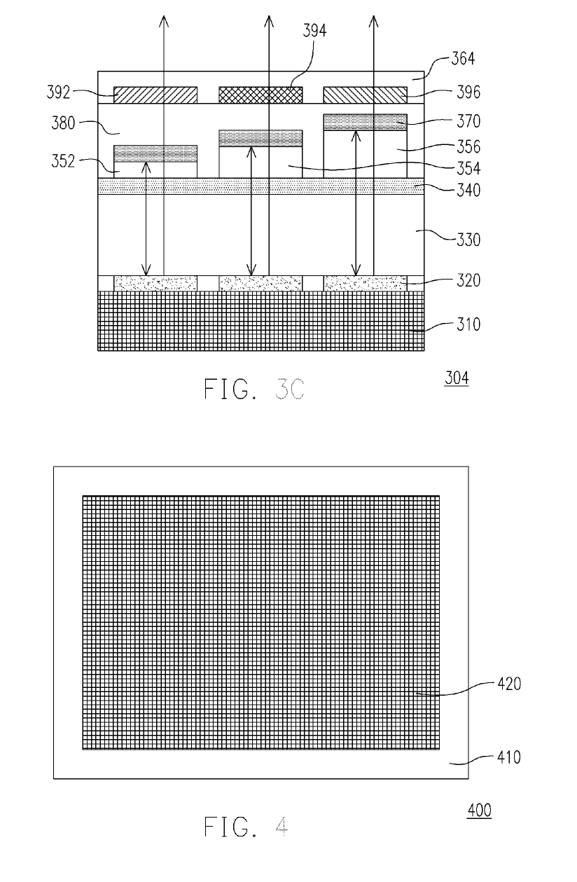

FIGS. 3A-3C are cross sectional views of the organic electro-luminescence elements according to another three embodiments of the present invention. Referring to FIG. 3A, the organic electro-luminescence element 300 in this embodiment is roughly the same with the organic electro-luminescence element 200 in the forgoing embodiment, only the difference will be described in here. The organic electro-luminescence element 300 has three kinds of transparent filler layers 352, 354 and 356 with different thicknesses. The transparent filler layers 352, 354 and 356 are disposed on the different positions of the second transparent electrode layer 340. The thickness of the transparent filler layer 356 is larger than the thickness of the transparent filler layer 354, and the thickness of the transparent filler layer 354 is larger than the thickness of the transparent filler layer 352. The transparent filler layers 352, 354 and 356 are covered by the semitransparent layer 370. Therefore, three kinds of resonant distance will exist in the organic electro-luminescence element 300, such that the light intensities and purities of the resonated light in three designated wavelength will be increased.

Furthermore, three color filters 392, 394 and 396 could be disposed on the semitransparent layer 370 and set above the transparent filler layer 352, 354 and 356, respectively. With the features described above, the intensities of the light with the wavelengths that suit to pass through the color filters 392, 394 and 396 can be enhanced by controlling the thickness of the transparent filler layers 352, 354 and 356, and the intensities and purities of the color lights that passed through the color filters 392, 394 and 396 can be improved. With the increases of the amounts and purities of the color lights that passed through the color filters 392, 394 and 396, if the color filters 392, 394 and 396 are respectively red, green and blue color filters, the lightness and the color rendering property of the white light that mixed with the color lights can be improved. Consequently, the deteriorated color uniformity of the image caused by the different transmittances of light to different color filters in conventional technology can be solved.

Moreover, the organic electro-luminescence element 300 may further include a transparent planar layer 380 that covers the semitransparent layer 370, and the color filters 392, 394 and 396 are disposed on the transparent planar layer 380. The transparent planar layer 380 can be used to flatten the surface and keep the outer moister, oxygen and other impurities away from the organic electro-luminescence element 300.

Referring to FIG. 3B, for protecting the color filters 392, 394 and 396, a cover substrate 362 can be disposed above the transparent planar layer 380, the color filters 392, 394 and 396 in the organic electro-luminescence element 302. Referring to FIG. 3C, the transparent planar layer 380, the color filters 392, 394 and 396 of the organic electro-luminescence element 304 is covered by a passivation layer 364.

FIG. 4 is a schematic drawing of an organic electro-luminescence display according to an embodiment of the present invention. The organic electro-luminescence display 400 essentially includes a substrate 410 and a plurality of organic electro-luminescence elements 420 disposed in array thereon. Wherein, each of the organic electro-luminescence elements 420 could be the organic electro-luminescence element 200 shown in FIG. 2 or the organic electro-luminescence element 300 shown in FIG. 3A. The substrate 410 functions as the substrate 210 shown in FIG. 2 or the substrate 310 shown in FIG. 3A, and all of the organic electro-luminescence elements 420 are disposed on the substrate 410. Therefore, the material and the characters of the substrate 410 is the same with the substrate 210 shown in FIG. 2. In the organic electro-luminescence display 400 of this embodiment, each of the organic electro-luminescence elements 420 includes single organic luminescent layer and various color filters, and the thicknesses of the transparent filler layers vary with the corresponding color filters. Hence, the defect caused by the different decay rates of the organic luminescent layers can be eliminated, and the lightness and purity of light in several designated wavelengths emitted by the organic electro-luminescence elements 420 can be improved, such that the color uniformity and the color saturation of the image displayed by the organic electro-luminescence display 400 will be superior.

Naturally, the cover substrate 362 shown in FIG. 3B and the passivation layer 364 shown in FIG. 3C can be provided in organic electro-luminescence display 400 for all of the organic electro-luminescence elements 420.

In summary, two or more kinds of resonate distances can be from with the different thicknesses of the filler layers in each of the organic electro-luminescence elements of the present invention. Consequently, the intensity and purity of the light emitted by the organic luminescent layers in several designated wavelengths can be improved. Moreover, the lengths of the resonant cavities could be adjusted according to the characters of the collocating color filters for increasing the transmittance of the light to the color filters, so as to improve the color uniformity and the color saturation of the image displayed by the organic electro-luminescence element and the organic electro-luminescence display of the present invention. Meanwhile, the semitransparent layer is integrated inside the package film that has smooth surface and excellent stability for keeping the organic electro-luminescence element away from the outer moister, oxygen and other impurities, and the peeling between the material layers and the substrate also can be avoid with better adhesion therebetween in addition.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic electro-luminescence element, comprising:
a first electrode layer;
an organic luminescent layer, disposed on the first electrode layer;
a second transparent electrode layer, disposed on the organic luminescent layer;
a first transparent filler layer, disposed on the second transparent electrode layer;
a second transparent filler layer, disposed on the second transparent electrode layer, and the thickness of the second transparent filler layer is larger than the thickness of the first transparent filler layer; and
a semitransparent layer, covering the first transparent filler layer and the second transparent filler layer.

2. The organic electro-luminescence element according to claim 1, further comprising a first color filter and a second color filter disposed on the semitransparent layer and set above the first transparent filler layer and the second transparent filler layer, respectively.

3. The organic electro-luminescence element according to claim 2, further comprising a transparent planar layer covering the semitransparent layer, and the first color filter and the second color filter are disposed on the transparent planar layer.

4. The organic electro-luminescence element according to claim 3, further comprising a passivation layer covering the transparent planar layer, the first color filter and the second color filter.

5. The organic electro-luminescence element according to claim 3, further comprising a cover substrate covering above the transparent planar layer, the first color filter and the second color filter.

6. The organic electro-luminescence element according to claim 1, further comprising a third transparent filler layer disposed on the second transparent electrode layer, the thickness of the third transparent filler layer is larger than the thickness of the second transparent filler layer, and the semitransparent layer covers the third transparent filler layer.

7. The organic electro-luminescence element according to claim 6, further comprising a first color filter, a second color filter and a third color filter disposed on the semitransparent layer and set above the first transparent filler layer, the second transparent filler layer and the third transparent filler layer, respectively.

8. The organic electro-luminescence element according to claim 7, wherein the first color filter, the second color filter and the third color filter are red color filter, green color filter and blue color filter, respectively.

9. The organic electro-luminescence element according to claim 7, further comprising a transparent planar layer covering the semitransparent layer, and the first color filter, the second color filter and the third color filter are disposed on the transparent planar layer.

10. The organic electro-luminescence element according to claim 9, further comprising a passivation layer covering the transparent planar layer, the first color filter, the second color filter and the third color filter.

11. The organic electro-luminescence element according to claim 9, further comprising a cover substrate covering above the transparent planar layer, the first color filter, the second color filter and the third color filter.

12. The organic electro-luminescence element according to claim 1, further comprising a substrate, and the first electrode layer is disposed on the substrate.

13. The organic electro-luminescence element according to claim 12, wherein the substrate includes glass substrate, silicon substrate or sapphire substrate.

14. The organic electro-luminescence element according to claim 12, wherein the substrate includes thin film transistor array substrate.

15. The organic electro-luminescence element according to claim 1, wherein the semitransparent layer includes a distributed Bragg reflector or a metal layer.

16. The organic electro-luminescence element according to claim 1, wherein the organic luminescent layer includes white light organic luminescent layer.

17. An organic electro-luminescence display, comprising:
a substrate;
a plurality of organic electro-luminescence elements, disposed in array on the substrate, each of the organic electro-luminescence element comprising:
a first electrode layer, disposed on the substrate;
an organic luminescent layer, disposed on the first electrode layer;
a second transparent electrode layer, disposed on the organic luminescent layer;
a first transparent filler layer, disposed on the second transparent electrode layer;
a second transparent filler layer, disposed on the second transparent electrode layer, and the thickness of the second transparent filler layer is larger than the thickness of the first transparent filler layer;
a semitransparent layer, covering the first transparent filler layer and the second transparent filler layer;
a first color filter, disposed on the semitransparent layer and set above the first transparent filler layer; and
a second color filter, disposed on the semitransparent layer and set above the second transparent filler layer.

18. The organic electro-luminescence display according to claim 17, wherein each of the organic electro-luminescence elements further comprising a transparent planar layer covering the semitransparent layer, and the first color filter and the second color filter are disposed on the transparent planar layer.

19. The organic electro-luminescence display according to claim 17, wherein each of the organic electro-luminescence elements further comprising:
a third transparent filler layer, disposed on the second transparent electrode layer, the thickness of the third transparent filler layer is larger than the thickness of the second transparent filler layer, and the semitransparent layer covers the third transparent filler layer; and
a third color filter, disposed on the semitransparent layer and set above the third transparent filler layer.

20. The organic electro-luminescence display according to claim 19, the first color filters, the second color filters and the third color filters are red color filters, green color filters and blue color filters, respectively.

21. The organic electro-luminescence display according to claim 19, wherein each of the organic electro-luminescence elements further comprising a transparent planar layer covering the semitransparent layer, and the first color filter, the second color filter and the third color filter are disposed on the transparent planar layer.

22. The organic electro-luminescence display according to claim 17, further comprising a passivation layer, covering on the organic electro-luminescence elements.

23. The organic electro-luminescence display according to claim 17, further comprising a cover substrate, covering above the organic electro-luminescence elements.

24. The organic electro-luminescence display according to claim 17, wherein the substrate includes glass substrate, silicon substrate or sapphire substrate.

25. The organic electro-luminescence display according to claim 17, wherein the substrate includes thin film transistor array substrate.

26. The organic electro-luminescence display according to claim 17, wherein the semitransparent layers include a distributed Bragg reflectors or a metal layer.

27. The organic electro-luminescence display according to claim 17, wherein the organic luminescent layers include white light organic luminescent layers.
